(19) United States
(12) Patent Application Publication
(10) Pub. No.: US 2013/0282555 A1
(43) Pub. Date: Oct. 24, 2013

(54) SYSTEM OF EXCHANGE TRADING (EMBODIMENTS)

(71) Applicants: Ilya Vladimirovich Kligman, St. Petersburg (RU); Sergey Vladimirovich Migalev, Rostov-na-Donu (RU)

(72) Inventors: Ilya Vladimirovich Kligman, St. Petersburg (RU); Sergey Vladimirovich Migalev, Rostov-na-Donu (RU)

(21) Appl. No.: 13/995,997

(22) PCT Filed: Dec. 30, 2010
(86) PCT No.: PCT/RU10/00808

§ 371 Date: Jun. 20, 2013

(51) Int. Cl. G06Q 40/04

(52) U.S. Cl. CPC G06Q 40/04
USPC 705/37

(57) ABSTRACT

An exchange trading system comprising of a computer-assisted device having a feature of access to information about tendering and output of this information to the users' terminals, as well as a feature of input of position for increase or decrease in the cost of a quotation and cost of one minimum price change for this quotation. Terminals for real time trading sessions on the exchange, such as a smartphone. The computer-assisted device is a server configured to enable taking a position and calculation of profit and loss within the amount of money on the user's account. The control unit for the personal user account state has a feature of control for the state of the user's account registered in the organization of trading host and crediting by means of payment systems and money input devices and transfer of money to the account or cash payment.

### CROSS-REFERENCE TO RELATED APPLICATIONS

The application is a National Phase of PCT/RU2010/000808, filed on Dec. 30, 2010, incorporated herein by reference in its entirety.

### BACKGROUND OF THE INVENTION

The invention relates to the systems for financial transactions, and to providing fast trading and fast distribution of material remuneration as a result of trading.

Conventional art teaches an exchange trading system comprising of a computer; a plurality of information sets about tendering received by the computer, where each of the information sets about tendering describes trading session of the first trader; a plurality of information sets about quotas of the trading received by the computer, where each of the information sets about quotas of the trading describes trading held by the order of the second trader; a set of the preset acceptable parameters of trading and software features carried out by the computer to compare information sets about tendering with information sets about quotas of the trading and to define coincidences if information set about tendering and information set about quotas of the trading conform within a set of preset acceptable trading parameters (see RU Patent No. 2259586).

A disadvantage of the conventional systems is its complexity not only in hardware but also in insufficient functionality that excludes remote access to the trading of other persons who are not officially registered for participation in trading.

Conventional art also teaches a remote communication terminal for trading on the exchange markets, comprising of a monitor and a push-button or touch keyboard or a touch monitor with a keyboard on a monitor screen, a payment card reader, a money input system, a device for remote connection in the form of a programming and computing unit having feature of graphic interface displaying with the fields for target information displaying, with the relevant control server for the user's account state, as well as a money output device. The programming and computing unit has a remote connection with servers of the exchange markets and information agencies for displaying in the specified fields of information about the current quotations, positions/positions and calculation of profit and loss for each transaction. The unit also has a feature of displaying of positions, with a feature of input of the price for a point change and a position amount through the keyboard and transfer of a premium to the account of a payment card holder or output of a premium through a money output device (RU Patent No. 64405, 2007).

The disadvantage of this system is that it does not provide for possible use of modern mechanisms of account crediting and receiving of a profit, also, control for the account state is assigned to a billing system that limits the user's possibilities to use money except for what available in the mobile network operator account.

Another conventional exchange trading system includes a computer-assisted device having a feature of access to information about tendering and output of this information to the users' terminals, as well as a feature of input of a position for increase or decrease in the cost of one currency pair and cost of one minimum price change for this currency pair, as well as control unit for the user's accounts, thus for real time trading sessions on the exchange.

A cell phone supporting a WAP mode is used as a terminal by means of which the tender calls a broker accredited on the exchange and gives instructions to buy/sale within those amounts which he transferred in advance to the exchange account (see the official site “Betforex.ru”, http:**www.betforex.ru/partner.html, where it is possible to hold trading sessions online, 2004-2005).

The disadvantage of this system is that to participate in trading sessions a trader at first has to transfer a fixed amount of money to the exchange account, sign a contract with a broker of this exchange, and his participation in trading is indirect, that is by giving instructions to the broker. Such a system is not flexible and does not allow to promptly solve a financial part of trading, for example, does not allow to promptly credit the account on the exchange to continue a session started and not to interrupt it. Use of a phone supporting a WAP mode is necessary only to have opportunity to receive quotations directly to the monitor and, based on the information received, to give instructions to the broker by the same phone.

### DETAILED DESCRIPTION OF THE PREFERRED EMBODIMENTS

Additional features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

The object of the present invention is to achieve the technical result consisting in enhancement of financial possibilities of access to trading sessions in remote access and real time mode.

The technical result for the first system is achieved in that the exchange trading system, including a computer-assisted device having access to information about tendering and output of this information to the users' terminals, as well as a feature of input of position for increase or decrease in the cost of at least one quotation and at least one cost of one minimum price change for this quotation, control unit for the user's accounts as well as terminals for real time trading sessions on the exchange, represented by the mobile communication devices supporting protocols of this communication or wireless data transmission technologies, thus the specified computer-assisted device is represented by a server having a feature of staking and calculation of profit and loss within the amount of money on the user's account, the specified computer-assisted device in the form of a server has a feature of the user's account state control on the basis of information of the mobile network operator billing system and transfer or withdrawal of money to/from this account following the trading results.

The claimed technical result for the second system is achieved in that the exchange trading system, including a computer-assisted device has access to information about tendering and output of this information to the users' terminals, as well as input of the user's market position for increase or decrease in the cost of at least one quotation and at least one cost of one minimum price change for this quotation, a control unit for the user's accounts as well as terminals for real time trading sessions on the exchange, represented by the mobile communication devices supporting protocols of this communication or wireless data transmission technologies. The computer-assisted device can be a server having a feature of taking positions and calculation of profit and loss within the amount of money on the user's account, a control unit for the user's accounts has control of the state of the user's account registered in the organization of trading host and its crediting by means of payment systems and money input devices and transfer of money to the personal account of the user or payment by cash.

The specified features achieve the desired technical result.

The present invention is explained by specific cases of embodiment which, however are not unique, but demonstrate possibility of achievement of demanded technical result.

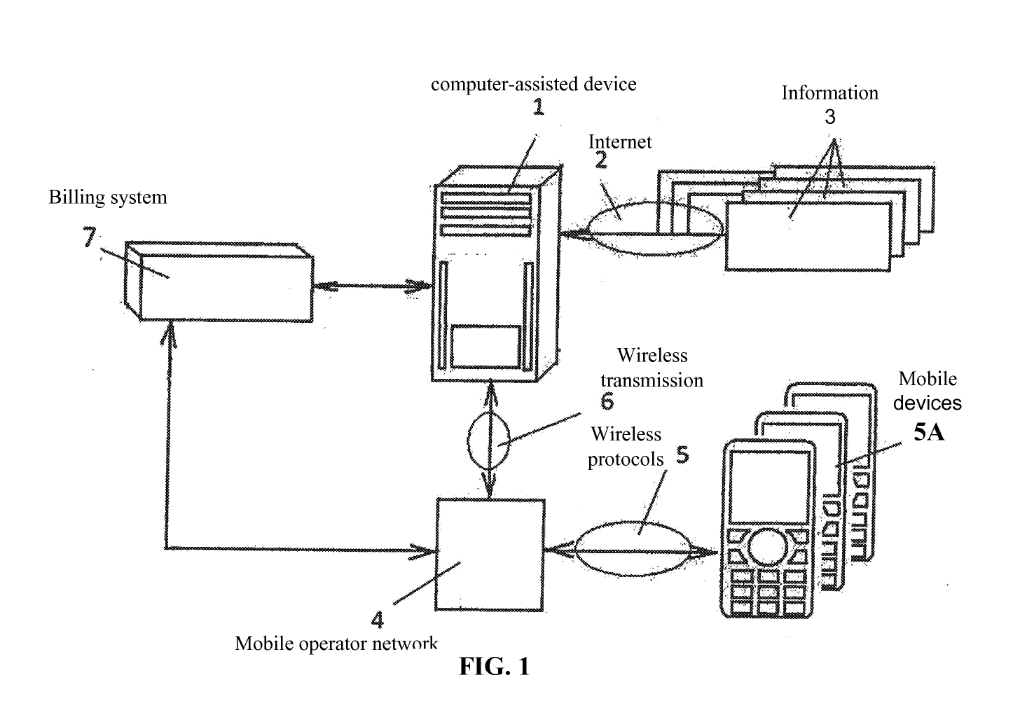

FIG. 1 shows a first design option of the system using a billing structure of the mobile network operator;

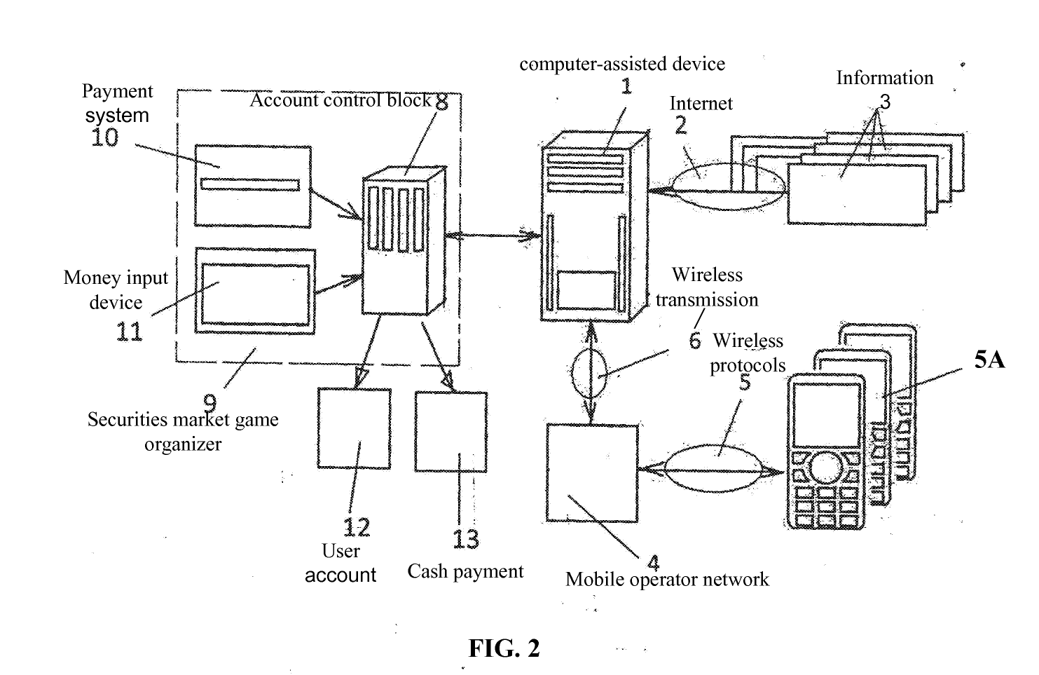

FIG. 2 shows a second design option of the system by the example of use of payment structure of the trading host.

According to the invention the first design option of the trading system is illustrated on FIG. 1. The system comprises the computer-assisted device 1 having access to the Internet 2, to information 3 about tendering and output of this information to the user's terminals 4, as well as feature of input of position for increase or decrease in the cost of one currency pair and cost of one minimum price change for this currency pair.

To provide possibility to hold trading sessions in real time mode the cell (mobile) phone 5A is used as the terminal functioning in the mobile operator network 4 supporting protocols 5 of this communication or wireless data transmission technologies 6.

The computer-assisted device 1 is represented by a server having a feature of staking and calculation of profit and loss within the amount of money on the user's account. This computer-assisted device 1 in the form of a server has a feature of the user's account state control on the basis of information of the mobile network operator 4 billing system 7 and transfer or writing off of money to/from this account following the trading results. The billing system 7 of the mobile network operator 4 is represented by the control unit for the users' accounts and for the positions and profit and loss calculation within the amount of money on the cell phone account of the user.

Using such sources as “Reuter”, “Tenfore”, “Bloomberg” through the WAP-MTS.RU service 4 quotations are displayed on the cell phone 5A, and transaction carried out by the client are recorded and processed. The client in real time mode makes transactions for currency pairs from the cell phone 5A within the amount of money on the phone account and transfers this information to the device 1. Payment of a profit (loss) to a fixed amount is made to the account or from the account of the cell phone user.

The second design option of the system is illustrated on FIG. 2. As distinct from the first design option, maintaining the main components of the system, except for the billing part, the second option has a control unit 8 for the user personal account state which having a feature of control for the state of the user's account registered in the organization 9 of trading host and its crediting by means of payment system 10 with different mechanisms and money input devices 11 and transfer of money to the personal account 12 of the user or payment by cash 13.

The present invention is industrially applicable as it can be implemented using real-life cell communication structures and remote access modes to information agencies.

What is claimed is:

1. An exchange trading system, comprising:
a computer-assisted device having access to information about securities market tendering and output of this information to a user terminal;
the user terminal displaying securities market positions increase or decrease in a cost of at least one quotation and at least one cost of one minimum price change for the quotation;
the terminal configured for real time trading sessions on the securities market;
wherein the terminal is implemented as a mobile communication devices supporting wireless data transmission protocols, and
wherein thus the computer-assisted device is a server configured to enable the user to take a position in the securities market and to calculate profit or loss so as to credit or debit a corresponding amount of money to the user's account, and
wherein the server controls a state of the user's account based on information from a billing system of a mobile network operator and is configured to transfer or withdraw of money to/from the user's account following the trading on the securities market by the user.

2. An exchange trading system, comprising:
a computer-assisted device having access to information about securities market tendering and output of this information to a user terminal;
the user terminal displaying securities market positions increase or decrease in a cost of at least one quotation and at least one cost of one minimum price change for the quotation;
the terminal configured for real time trading sessions on the securities market;
wherein the terminal is implemented as a mobile communication devices supporting wireless data transmission protocols,
wherein thus the computer-assisted device is a server configured to enable the user to take a position in the securities market and to calculate profit or loss so as to credit or debit a corresponding amount of money to the user's account,
wherein the server controls a state of the user's account based on information from a billing system of a mobile network operator and is configured to transfer or withdraw of money to/from the user's account following the trading on the securities market by the user, and
wherein the user account is registered with trading host and the trading host credits the user account through a payment system and money input devices and a transfer of money to the personal account of the user or a cash payment.
